(19) United States
(12) Patent Application Publication
(10) Pub. No.: US 2014/0071131 A1
(43) Pub. Date: Mar. 13, 2014

(54) IMAGE PROCESSING APPARATUS, IMAGE PROCESSING METHOD AND PROGRAM

(71) Applicant: CANNON KABUSHIKI KAISHA, Tokyo (JP)

(72) Inventor: Masaki Kitago, Misato-shi (JP)

(73) Assignee: CANNON KABUSHIKI KAISHA, Tokyo (JP)

(21) Appl. No.: 14/017,848

(22) Filed: Sep. 4, 2013

(30) Foreign Application Priority Data
Sep. 13, 2012 (JP) 2012-201478

(51) Int. Cl. G06T 17/00

(52) U.S. Cl. CPC G06T 17/00
USPC 345/427

(57) ABSTRACT

In the free viewpoint image combination technique, captured images between respective viewpoints are combined with high precision and at a high speed. As to an occlusion region, a free viewpoint image is generated by use of distance information from another viewpoint.

### BACKGROUND OF THE INVENTION

1. Field of the Invention

The present invention relates to a free viewpoint image combination technique using data of images captured from a plurality of viewpoints and distance information and, more particularly, to a free viewpoint image combination technique of data of multi-viewpoint images captured by a camera array image capturing device.

2. Description of the Related Art

In recent years, 3D contents are utilized actively mainly in the cinema industry. In order to achieve a higher sense of presence, the development of the multi-viewpoint image capturing technique and the multi-viewpoint display technique is in progress.

In the two-viewpoint display, a glasses-type 3D display is the mainstream. By generating image data for the right eye and image data for the left eye and switching the images viewed by each eye by the control of the glasses, a viewer can view a stereoscopic image. Further, as to the multi-viewpoint display, the lenticular lens and the glasses-less 3D display using the parallax barrier system are developed and utilized mainly for the purposes of digital signage.

In the image capturing device also, a stereo camera is developed for two-viewpoint image capturing and the camera array image capturing device (also referred to simply as a “camera array”, as known as camera array system, multiple lens camera, and the like), such as the Plenoptic camera and the camera array system, is developed for multi-viewpoint (three- or more-viewpoint) image capturing. Further, the research in the field called computational photography capable of capturing multi-viewpoint images by devising the image capturing device with comparatively less modification of the already existing camera configuration is aggressively in progress.

In the case where the multi-viewpoint image captured by the camera array image capturing device is displayed in the multi-viewpoint display device, it is necessary to adjust the difference in the number of viewpoints between the image capturing device and the display device. For example, in the case where a three-viewpoint image captured by a triple lens camera is displayed in a nine-viewpoint glasses-less 3D display, it is necessary to generate complementary images corresponding to six viewpoints from which no image is captured. Further, in the case where an image captured by a stereo camera is displayed in a glasses-type 3D display, although both have two viewpoints, the parallax optimum to viewing and listening is different depending on the display, and therefore, there is a case where the image is reconfigured from a viewpoint different from that of the captured image and output.

In order to implement the use cases as above, as a technique to generate image data from a viewpoint other than that of a captured image, a free viewpoint image combination technique is developed.

As a related technique, the standardization of MPEG-3DV (3D Video Coding) is in progress. MPEG-3DV is a scheme to encode depth information as well as multi-viewpoint image data. On the assumption that from the input of multi-viewpoint image data, outputs are produced for display devices with various numbers of viewpoints, such as the already-existing 2D display, the glasses-type 3D display, and the glasses-less 3D display, the number of viewpoints is controlled by use of the free viewpoint image combination technique. Further, as a technique to view and listen to a multi-view point video in a dialog manner also, the free viewpoint image combination technique is developed (Japanese Patent Laid-Open No. 2006-012161).

### SUMMARY OF THE INVENTION

As a problem in the free viewpoint image combination technique, mention is made of improvement in image quality of a combined image and suppression of the amount of calculation. In free viewpoint image combination, an image from a virtual viewpoint is combined from a group of multi-viewpoint reference images. First, an image from a virtual viewpoint is generated from each reference image, but there occurs a deviation between generated virtual viewpoint images due to an error of distance information. Next, a group of virtual viewpoint images generated from each reference image are combined, but in the case where a group of virtual viewpoint images between which a deviation exists are combined, blurring occurs in the resultant combined image. Further, as the number of reference images and the number of image regions utilized for image combination increase, the amount of calculation will increase.

The image processing apparatus according to the present invention has an identification unit configured to identify an occlusion region in which an image cannot be captured from a first viewpoint position, a first acquisition unit configured to acquire first image data of a region other than the occlusion region obtained in the case where an image of a subject is captured from an arbitrary viewpoint position based on a three-dimensional model generated by using first distance information indicative of the distance from the first viewpoint position to the subject and taking the first viewpoint position as a reference, a second acquisition unit configured to acquire second image data of the occlusion region obtained in the case where the image of the subject is captured from the arbitrary viewpoint position based on a three-dimensional model of the occlusion region generated by using second distance information indicative of the distance from a second viewpoint position different from the first viewpoint position to the subject and taking the second viewpoint position as a reference, and a generation unit configured to generate combined image data obtained in the case where the image of the subject is captured from the arbitrary viewpoint position by combining the first image data and the second image data.

According to the present invention, it is possible to perform free viewpoint image combination using multi-view point image data with high image quality and at a high speed.

Further features of the present invention will become apparent from the following description of exemplary embodiments (with reference to the attached drawings).

### BRIEF DESCRIPTION OF THE DRAWINGS

FIG. 1 is diagram showing an example of a camera array image capturing device including a plurality of image capturing units.

FIG. 2 is a block diagram showing an internal configuration of a camera array image processing apparatus.

FIG. 3 is a diagram showing an internal configuration of the image capturing unit.

FIG. 4 is a function block diagram showing an internal configuration of an image processing unit.

FIG. 5 is a flowchart showing a flow of distance information estimation processing.

FIGS. 6A to 6E are diagrams for explaining a process of the distance information estimation processing: FIGS. 6A and 6C are diagrams each showing an example of a viewpoint image;

FIG. 6B is a diagram showing a state where the viewpoint image is filtered and divided into small regions; FIG. 6D is a diagram showing a state where one viewpoint image is overlapped by a small region in a viewpoint image of another image capturing unit; and FIG. 6E is a diagram showing a state where the deviation that occurs in FIG. 6D is eliminated.

FIGS. 7A and 7B are diagrams showing an example of a histogram: FIG. 7A shows a histogram having a high peak; and FIG. 7B shows a histogram having a low peak, respectively.

FIGS. 8A and 8B are diagrams for explaining adjustment of an initial amount of parallax.

FIG. 9 is a flowchart showing a flow of image separation processing.

FIG. 10 is a diagram for explaining the way each pixel within a viewpoint image is classified into two; a boundary pixel and a normal pixel.

FIG. 11 is a flowchart showing a flow of free viewpoint image generation processing.

FIG. 12 is a diagram for explaining generation of a three-dimensional model of a main layer.

FIG. 13 is a diagram for explaining the way of rendering the main layer.

FIGS. 14A to 14D are diagrams showing an example in the case where rendering of the main layer of a representative image is performed at a viewpoint position of an auxiliary image.

FIGS. 15A and 15B are diagrams for explaining the way of generating an auxiliary main layer.

FIGS. 16A to 16E are diagrams showing an example of a rendering result of the main layer and the auxiliary main layer.

FIG. 17 is a diagram for explaining the way of generating a three-dimensional model of a boundary layer.

FIG. 18 is a diagram for explaining the way of rendering the boundary layer.

FIG. 19 is a diagram for explaining the way of generating an auxiliary main layer in a second embodiment.

### DESCRIPTION OF THE EMBODIMENTS

Hereinafter, with reference to the attached drawings, preferred embodiments of the present invention are explained.

### First Embodiment

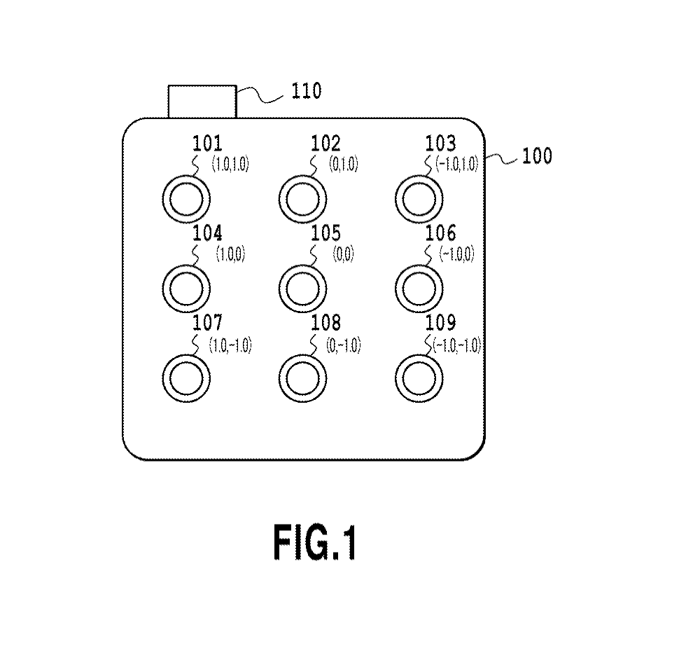

FIG. 1 is a diagram showing an example of a camera array image processing apparatus including a plurality of image capturing units according to a first embodiment.

A chassis of an image capturing device 100 includes nine image capturing units 101 to 109 which acquire color image data and an image capturing button 110. All the nine image capturing units have the same focal length and are arranged uniformly on a square lattice.

Upon pressing down of the image capturing device 100 by a user, the image capturing units 101 to 109 receive optical information of a subject by a sensor (image capturing element) and the received signal is A/D-converted and a plurality of color images (digital data) is acquired at the same time.

By the camera array image capturing device described above, it is possible to obtain a group of color images (multi-viewpoint image data) of the same subject captured from a plurality of viewpoint positions.

Here, the number of image capturing units is set to nine, but the number of image capturing units is not limited to nine. The present invention can be applied as long as the image capturing device has a plurality of image capturing units. Further, the example in which the nine image capturing units are arranged uniformly on a square lattice is explained here, but the arrangement of the image capturing units is arbitrary. For example, it may also be possible to arrange them radially or linearly or quite randomly.

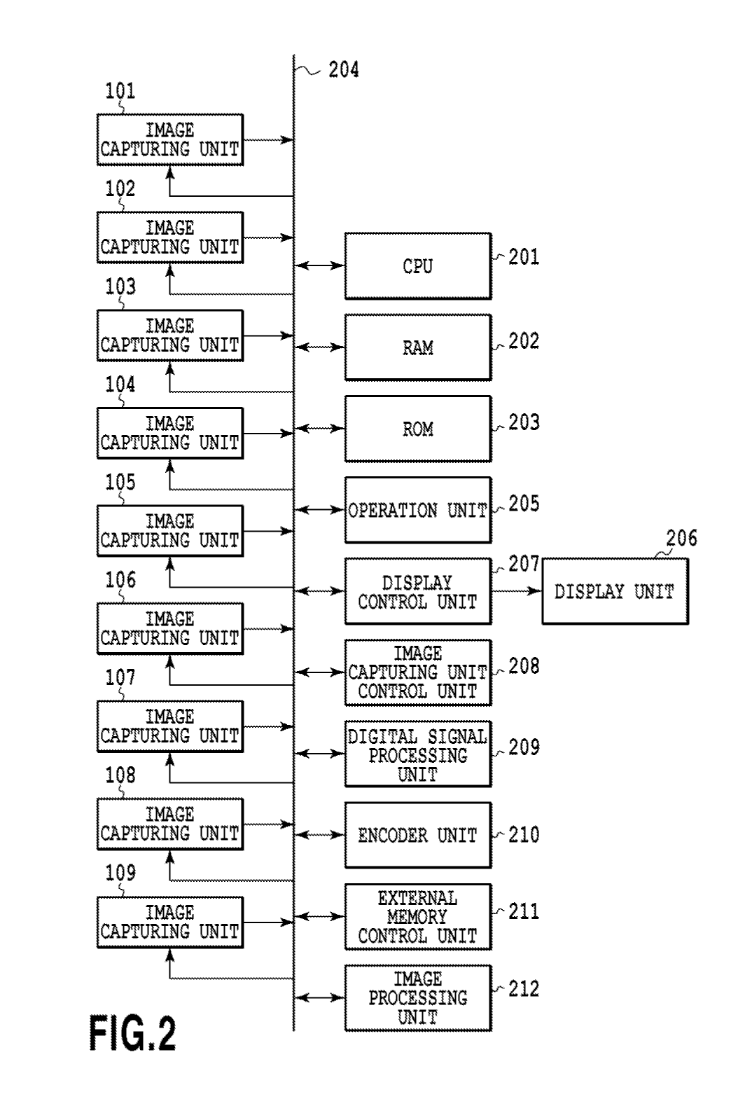

FIG. 2 is a block diagram showing an internal configuration of the image capturing device 100.

A central processing unit (CPU) 201 totally controls each unit described below.

A RAM 202 functions as a main memory, a work area, etc. of the CPU 201.

A ROM 203 stores control programs etc. executed by the CPU 201.

A bus 204 is a transfer path of various kinds of data and, for example, digital data acquired by the image capturing units 101 to 109 is transferred to a predetermined processing unit via the bus 204.

An operation unit 205 corresponds to buttons, mode dial, etc. and via which instructions of a user are input.

A display unit 206 displays captured images and characters. In the display unit 206, a liquid crystal display is widely used in general. Further, the display unit 206 may have a touch screen function and in such a case, it is also possible to handle instructions of a user using the touch screen as an input to the operation unit 205.

A display control unit 207 performs display control of images and characters displayed in the display unit 206.

An image capturing unit control unit 208 performs control of an image capturing system based on instructions from the CPU 201, such as focusing, shutter releasing and closing, and stop adjustment.

A digital signal processing unit 209 performs various kinds of processing, such as white balance processing, gamma processing, and noise reduction processing, on the digital data received via the bus 204.

An encoder unit 210 performs processing to convert digital data into a predetermined file format.

An external memory control unit 211 is an interface to connect to a PC and other media (for example, hard disk, memory card, CF card, SD card, USB memory).

An image processing unit 212 calculates distance information from the multi-viewpoint image data acquired by the image capturing units 101 to 109 or the multi-viewpoint image data output from the digital signal processing unit 209, and generates free viewpoint combined image data. Details of the image processing unit 212 will be described later.

The image capturing device includes components other than those described above, but they are not the main purpose of the present invention, and therefore, explanation thereof is omitted.

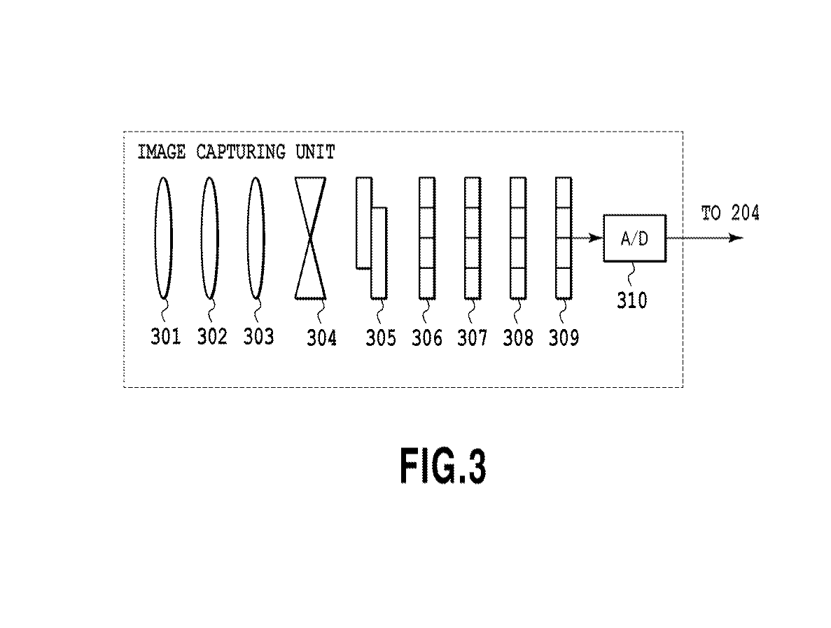

FIG. 3 is a diagram showing an internal configuration of the image capturing units 101 to 109.

The image capturing units 101 to 109 include lenses 301 to 303, a stop 304, a shutter 305, an optical low-pass filter 306, an iR cut filter 307, a color filter 308, a sensor 309, and an A/D conversion unit 310. The lenses 301 to 303 are a zoom lens 301, a focus lens 302, and a camera shake correction lens 303, respectively. The sensor 309 is a sensor, for example, such as a CMOS and CCD.

In the case where the sensor 309 detects an amount of light of the subject, the detected amount of light is converted into a digital value by the A/D conversion unit 310 and output to the bus 204 as digital data.

In the present embodiment, the configuration and processing of each unit are explained on the premise that all images captured by the image capturing units 101 to 109 are color images, but part of or all the images captured by the image capturing units 101 to 109 may be changed into monochrome images. In such a case, the color filter 308 is omitted.

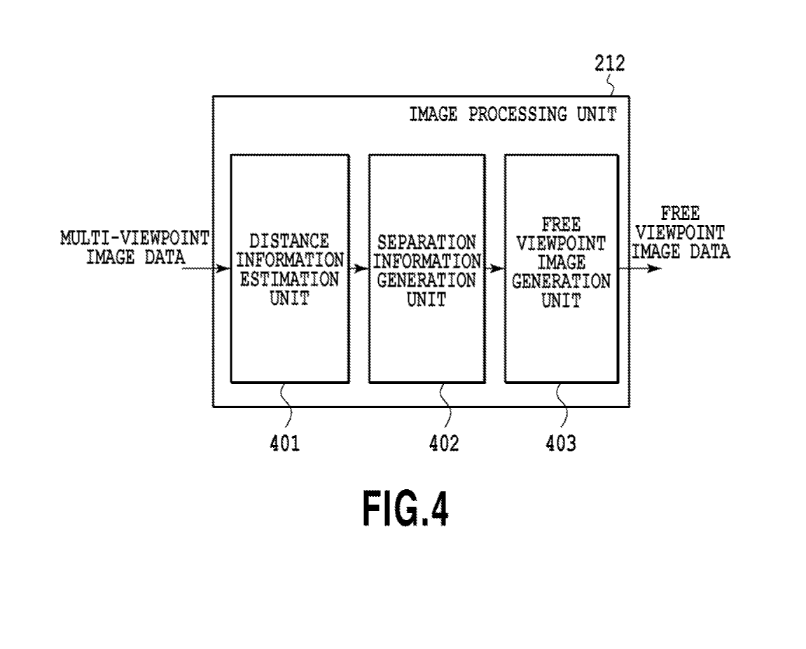

FIG. 4 is a function block diagram showing an internal configuration of the image processing unit 212.

The image processing unit 212 has a distance information estimation unit 401, a separation information generation unit 402, and a free viewpoint image generation unit 403. The image processing unit 212 in the embodiment is explained as one component within the image capturing device, but it may also be possible to implement the function of the image processing unit 212 by an external device, such as a PC. That is, it is possible to implement the image processing unit 212 in the present embodiment as one function of the image capturing device or as an independent image processing apparatus.

Hereinafter, each component of the image processing unit 212 is explained.

The color multi-viewpoint image data acquired by the image capturing units 101 to 109 or the color multi-viewpoint image data output from the digital signal processing unit 209 (in the present embodiment, the number of viewpoints is nine in each case) input to the image processing unit 212 is first sent to the distance information estimation unit 401.

The distance information estimation unit 401 estimates distance information indicative of the distance from the image capturing unit to the subject (hereinafter, referred to as “distance information”) for each image at each viewpoint within the input multi-viewpoint image data. Details of the distance information estimation will be described later. The configuration may also be such that equivalent distance information is input from outside instead of the provision of the distance information estimation unit 401.

The separation information generation unit 402 generates information (separation information) that serves as a basis on which each viewpoint image configuring the multi-viewpoint image data is separated into two layers (a boundary layer that is a boundary of the subject and a main layer other than the boundary layer that is not a boundary of the subject). Specifically, each pixel within each viewpoint image is classified into two kinds of pixels, that is, a boundary pixel adjacent to the boundary of the subject (hereinafter, referred to as an “object boundary”) and a normal pixel other than the boundary pixel, and information enabling identification of the kind to which each pixel corresponds is generated. Details of separation information generation will be described later.

The free viewpoint image generation unit 403 generates image data at an arbitrary viewpoint position (free viewpoint image data) by rendering each three-dimensional model of the main layer (including the auxiliary main layer) and the boundary layer. Details of free viewpoint image generation will be described later.

### (Distance Information Estimation Processing)

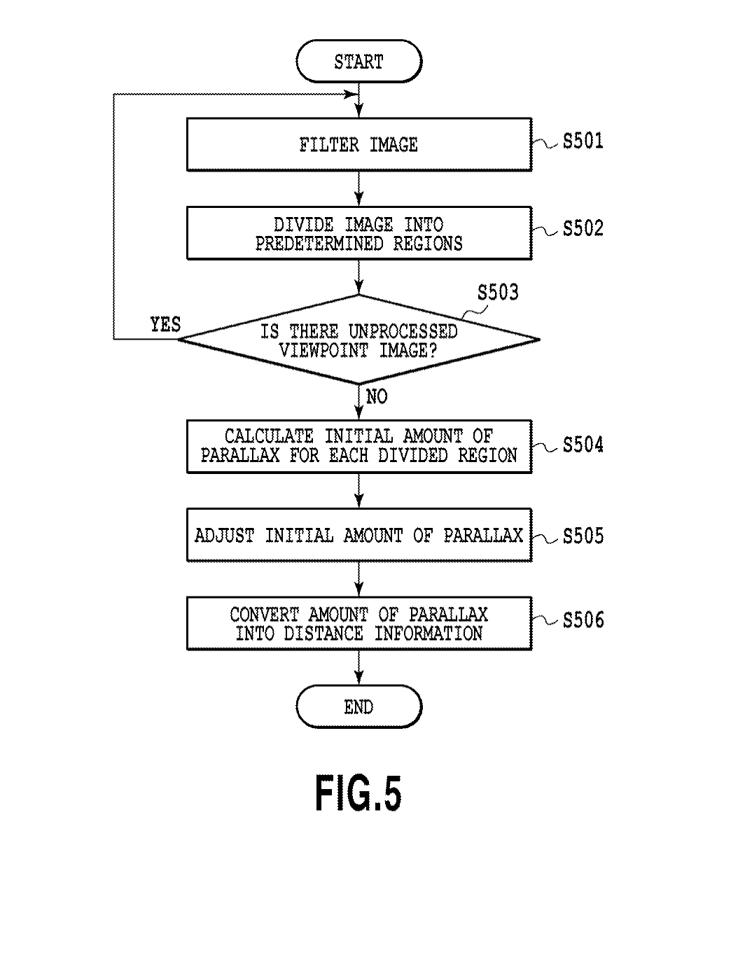

A method for estimating distance information in the distance information estimation unit 401 is explained. FIG. 5 is a flowchart showing a flow of the distance information estimation processing according to the present embodiment. In the following, explanation is given on the premise that the multi-viewpoint image data that is input is the data of images from nine viewpoints captured by the image capturing device 100 having the nine image capturing units 101 to 109 shown in FIG. 1.

At step 501, the distance information estimation unit 401 applies an edge-preserving smoothing filter to one viewpoint image (target viewpoint image) within the nine-viewpoint image data that is input.

At step 502, the distance information estimation unit 401 divides the target viewpoint image into regions of a predetermined size (hereinafter, referred to as “small regions”). Specifically, neighboring pixels (pixel group) the color difference between which is equal to or less than a threshold value are integrated sequentially and the target viewpoint image is finally divided into small regions having a predetermined number of pixels (for example, regions having 100 to 1,600 pixels). The threshold value is set to a value appropriate to determine that colors to be compared are about the same color, for example, to “6” in the case where RGB are quantized by eight bits (256 colors), respectively. At first, neighboring pixels are compared and in the case where the color difference is equal to or less than the above-mentioned threshold value, both pixels are integrated. Next, the average colors of the integrated pixel groups are obtained, respectively, and compared with the average colors of neighboring pixel groups, and then, the pixel groups the color difference between which is equal to or less than the threshold value are integrated. The processing as described above is repeated until the size (number of pixels) of the pixel group reaches the small region configured by the fixed number of pixels described above.

At step 503, the distance information estimation unit 401 determines whether the division into small regions is completed for all the nine viewpoint images included in the nine-viewpoint image data. In the case where the division into small regions is completed, the procedure proceeds to step 504. On the other hand, in the case where the division into small regions is not completed yet, the procedure returns to step 501 and the processing to apply the smoothing filter and the processing to divide into small regions are performed by using the next viewpoint image as the target viewpoint image.

At step 504, the distance information estimation unit 401 calculates the initial amount of parallax of each divided small region for all the viewpoint images by referring to the viewpoint images around each viewpoint image (here, the viewpoint images located above, below, to the right, and to the left of each viewpoint image). For example, in the case where the initial amount of parallax of the viewpoint image relating to the image capturing unit 105 at the center is calculated, each viewpoint image of the image capturing units 102, 104, 106, and 108 is referred to. In the case of the viewpoint image relating to the image capturing unit at the end part, for example, for the viewpoint image of the image capturing unit 107, each viewpoint image of the image capturing units 104 and 108 is referred to and in the case of the viewpoint image of the image capturing unit 108, each viewpoint image of the image capturing units 105, 107, and 109 is referred to and thus the initial amount of parallax is calculated. The calculation of the initial amount of parallax is performed as follows.

First, each small region of the viewpoint image for which the initial amount of parallax is to be found and the corresponding small region in the viewpoint image to be referred to (reference viewpoint image) are compared. Here, the corresponding small region is the small region in the reference viewpoint image shifted by the amount corresponding to the parallax relative to the position of each small region of the viewpoint image for which the initial amount of parallax is to be found.

Next, the color difference between each pixel of the viewpoint image for which the initial amount of parallax is to be found and the corresponding pixel in the reference viewpoint image shifted by the amount corresponding to the parallax is calculated for all the pixels within the small region and a histogram is created.

Then, each histogram is created by changing the amount of parallax.

In the histogram obtained in this manner, the amount of parallax whose peak is high is the initial amount of parallax. The corresponding region in the viewpoint image to be referred to is set by adjusting the amount of parallax in the longitudinal direction and in the transverse direction. The reason is that the amount of parallax of one pixel in the longitudinal direction and the amount of parallax of one pixel in the transverse direction do not indicate the same distance.

The processing hitherto is explained by using a specific example.

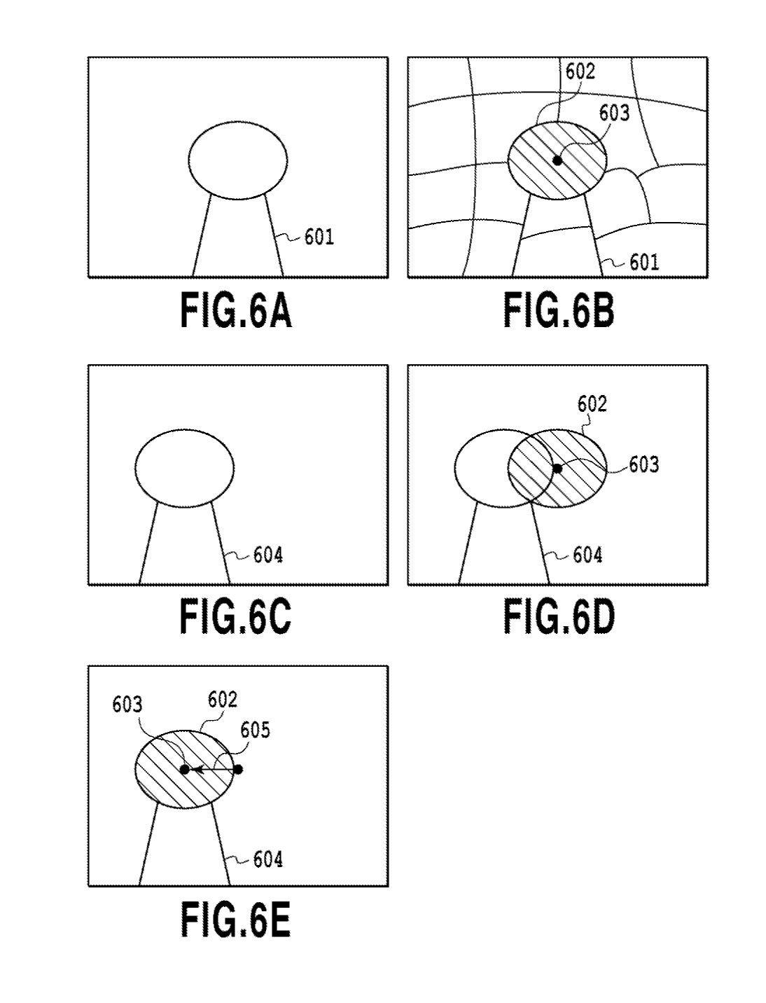

FIG. 6A is a diagram showing an example of the viewpoint image of the image capturing unit 105 and the image of an object 601 is shown. FIG. 6B is a diagram showing a state where an edge-preserving filer is applied to the viewpoint image of the image capturing unit 105 and the viewpoint image is divided into small regions. Here, one of the small regions is referred to as a small region 602 and the center coordinate of the small region 602 is denoted by 603. FIG. 6C is a diagram showing an example of the viewpoint image of the image capturing unit 104. In the case of the image capturing unit 104, the image of the same object is captured from the right side of the image capturing unit 105, and therefore, the image of an object 604 in the viewpoint image of the image capturing unit 104 is shown on the left side of the object 601 in the viewpoint image of the image capturing unit 105.

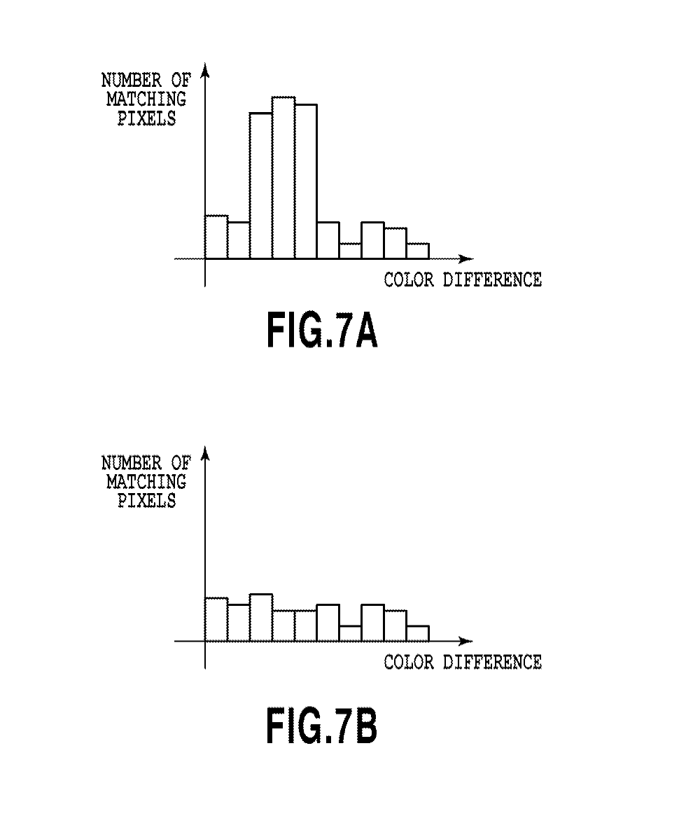

Here, the comparison of the corresponding regions with the small region 602 as the target is performed by assuming the target viewpoint image as the viewpoint image of the image capturing unit 105 and the viewpoint image to be referred to as the viewpoint image of the image capturing unit 104. FIG. 6D shows a state where the viewpoint image of the image capturing unit 104 is overlapped by the small region 602 in the viewpoint image of the image capturing unit 105 and there is a deviation between the corresponding regions. Then, the comparison between the pixel value of the small region 602 in the viewpoint image (to which the edge-preserving filter is applied) of the image capturing unit 105 and the pixel value in the viewpoint image (to which the edge-preserving filter is applied) of the image capturing unit 104 is performed and thus a histogram is created. Specifically, the color difference between each pixel in the corresponding small regions is acquired and the color difference is represented by the horizontal axis and the number of matching pixels is represented by the vertical axis. In this manner, by changing the amount of parallax (for example, by moving the small region by one pixel each time), the histogram for each amount of parallax is created sequentially. FIGS. 7A and 7B show examples of the histogram and the histogram distribution having a high peak as in FIG. 7A is determined to have high reliability in the amount of parallax and the histogram distribution having a low peak as in FIG. 7B is determined to have poor reliability in the amount of parallax. Here, the amount of parallax of the histogram having a high peak is set as the initial amount of parallax. FIG. 6E shows a state where the deviation that has occurred in FIG. 6D is eliminated and the small region 602 in the viewpoint image of the image capturing unit 105 overlaps the corresponding region in the viewpoint image of the image capturing unit 104 with no deviation. The amount of parallax indicated by an arrow 605 in FIG. 6E corresponds to the initial amount of parallax to be found. Here, the histogram is created by moving the small region by one pixel each time, but the amount of movement may be set to an arbitrary amount, such as by moving the small region by an amount corresponding to 0.5 pixels each time.

Explanation is returned to the flowchart in FIG. 5.

At step 505, the distance information estimation unit 401 repeatedly adjusts the initial amount of parallax by using the color difference between small regions, the difference in the initial amount of parallax, etc. Specifically, the initial amount of parallax is adjusted based on the idea that small regions adjacent to each other and the color difference between which is small have a strong possibility of having similar amounts of parallax and that small regions adjacent to each other and the difference in the initial amount of parallax between which is small have a strong possibility of having similar amounts of parallax.

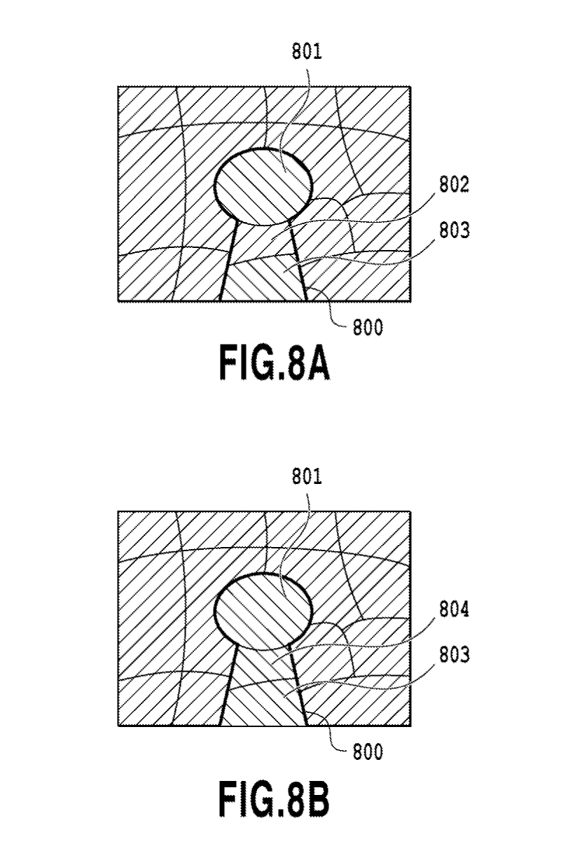

FIGS. 8A and 8B are diagrams for explaining the adjustment of the initial amount of parallax. FIG. 8A is a diagram showing the result of calculation of the initial amount of parallax for each small region in FIG. 6B (the state before adjustment) and FIG. 8B is a diagram showing the state after the adjustment is performed. In FIG. 8A, the amounts of parallax of three small regions in an object region 800 (region inside a heavy line) are represented by diagonal lines 801, diagonal lines 802, and diagonal lines 803, respectively. Here, the diagonal lines 801 and 803 are diagonal lines extending from upper left to lower right and the diagonal line 802 is a diagonal line extending from upper right to lower left and this difference indicates that the amounts of parallax are different between both. In this case, it is assumed that the diagonal line extending from upper right to lower left indicates the correct amount of parallax for the background region (region outside the heavy line) and the diagonal line extending from upper left to lower right indicates the correct amount of parallax for the object region. In FIG. 8A, as to the amounts of parallax 801 and 803, the correct amount of parallax is calculated as the amount of parallax of the object region, but as to the amount of parallax 802, the amount of parallax of the background region is already calculated and it is known that the correct amount of parallax is not calculated. In the adjustment of the amount of parallax, the error that occurs at the time of estimation of the amount of parallax for each small region as described above is corrected by utilizing the relationship between the small region and the surrounding small regions. For example, the amount of parallax 802, which has been the amount of parallax of the background region in the case of FIG. 8A, is corrected to a correct amount of parallax 804 represented by the diagonal line extending from upper left to lower right as shown in FIG. 8B as the result of the adjustment by utilizing the amount of parallax 801 and the amount of parallax 803 of the small regions adjacent thereto.

At step 506, the distance information estimation unit 401 obtains distance information by performing processing to convert the amount of parallax obtained by the adjustment of the initial amount of parallax into a distance. The distance information is calculated by (camera interval×focal length)/(amount of parallax×length of one pixel), but the length of one pixel is different between the longitudinal direction and the transverse direction, and therefore, necessary conversion is performed so that the amount of parallax in the longitudinal direction and that in the transverse direction indicate the same distance.

Further, the converted distance information is quantized, for example, into eight bits (256 gradations). Then, the distance information quantized into eight bits is saved as 8-bit grayscale (256-gradation) image data (distance map). In the grayscale image of the distance information, the shorter the distance between the object and the camera, the closer to white (value: 255), the color of the object is, and the greater the distance between the object and the camera, the closer to black (value: 0), the color of the object is. For example, an object region 800 in FIGS. 8A and 8B are represented by white and the background region is represented by black. It is of course possible to quantize the distance information into another number of bits, such as 10 bits and 12 bits, and to save the distance information as a binary file without performing quantization.

In this manner, the distance information corresponding to each pixel of each viewpoint image is calculated. In the present embodiment, the distance is calculated by dividing the image into small regions including a predetermined number of pixels, but it may also be possible to use another estimation method that obtains the distance based on the parallax between multi-viewpoint images.

The distance information corresponding to each viewpoint image obtained by the above-mentioned processing and the multi-viewpoint image data are sent to the subsequent separation information generation unit 402 and the free viewpoint image generation unit 403. It may also be possible to send the distance information corresponding to each viewpoint image and the multi-viewpoint image data only to the separation information generation unit 402 and to cause the separation information generation unit 402 to send the data to the free viewpoint image generation unit 403.

### (Separation Information Generation Processing)

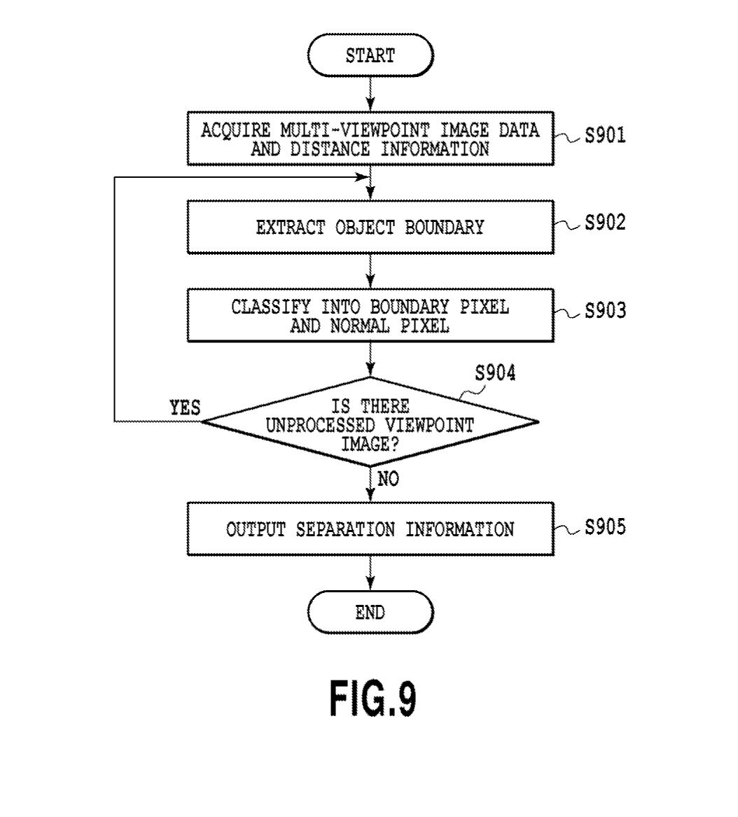

Next, processing to separate each viewpoint image into two layers, that is, the boundary layer in the vicinity of the boundary of the object in the image and the main layer other than the boundary of the object in the separation information generation unit 402 is explained. FIG. 9 is a flowchart showing a flow of the image separation processing according to the present embodiment.

At step 901, the separation information generation unit 402 acquires the multi-viewpoint image data and the distance information obtained by the distance information estimation processing.

At step 902, the separation information generation unit 402 extracts the object boundary within the viewpoint image. In the present embodiment, the portion where the difference between the distance information of the target pixel and the distance information of the neighboring pixel (hereinafter, referred to as a “difference in distance information”) is equal to or more than the threshold value is identified as the boundary of the object. Specifically, the object boundary is obtained as follows.

First, scan is performed in the longitudinal direction, the difference in distance information and the threshold value are compared and the pixel whose difference in distance information is equal to or more than a threshold value is identified. Next, scan is performed in the transverse direction, the difference in distance information and the threshold value are compared similarly and the pixel whose difference in distance information is equal to or more than the threshold value is identified. Then, the sum-set of the pixels identified in the longitudinal direction and in the transverse direction, respectively, is calculated and identified as the object boundary. The threshold value is set to a value, for example, such as “10”, in the case where the distance information is quantized into eight bits (0 to 255).

Here, the object boundary is obtained based on the distance information, but it may also be possible to use another method, such as a method for obtaining the object boundary by dividing an image into regions. However, it is desirable for the object boundary obtained by the region division of the image and the object boundary obtained from the distance information to agree with each other as much as possible. In the case where the object boundary is obtained by the region division of the image, it is suggested to correct the distance information in accordance with the obtained object boundary.

At step 903, the separation information generation unit 402 classifies each pixel within the viewpoint image into two kinds of pixels, that is, the boundary pixel and the normal pixel. Specifically, with reference to the distance information acquired at step 901, the pixel adjacent to the object boundary identified at step 902 is determined to be the boundary pixel.

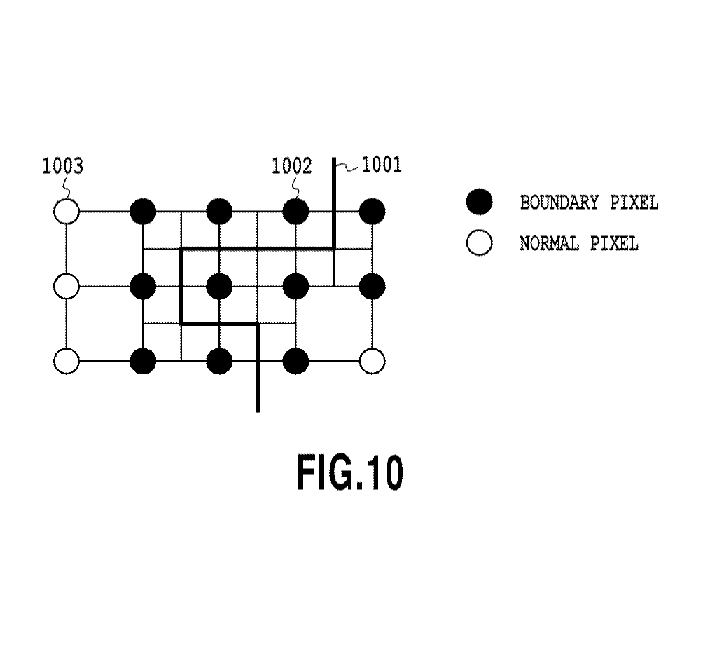

FIG. 10 is a diagram for explaining the way each pixel within the viewpoint image is classified into two; the boundary pixel and the normal pixel. Neighboring pixels astride an object boundary 1001 are classified as boundary pixels 1002 and remaining pixels are classified as normal pixels 1003, respectively. Here, only one pixel adjacent to the object boundary 1001 is classified as the boundary pixel, but for example, it may also be possible to classify two pixels adjacent to the object boundary (within the width corresponding to two pixels from the object boundary 1001) as the boundary pixels. As long as it is possible to identify the boundary pixels in the vicinity of the object boundary and the normal pixels other than the boundary pixels, any classification may be used.

At step 904, the separation information generation unit 402 determines whether the classification of the pixels of all the viewpoint images included in the input multi-viewpoint image data is completed. In the case where there is an unprocessed viewpoint image not subjected to the processing yet, the procedure returns to step 902 and the processing at step 902 and step 903 is performed on the next viewpoint image. On the other hand, in the case where the classification of the pixels of all the viewpoint images is completed, the procedure proceeds to step 905.

At step 905, the separation information generation unit 402 sends separation information capable of identifying the boundary pixel and the normal pixel to the free viewpoint image generation unit 403. For the separation information, for example, it may be considered that a flag “1” is attached separately to the pixel determined to be the boundary pixel and a flag “0” to the pixel determined to be the normal pixel. However, in the case where the boundary pixels are identified, it becomes clear that the rest of the pixels are the normal pixels, and therefore, it is sufficient for the separation information to be information capable of identifying the boundary pixels. In the free viewpoint image generation processing to be described later, a predetermined viewpoint image is separated into two layers (that is, the boundary layer configured by the boundary pixels and the main layer configured by the normal pixels) by using the separation information as described above.

### (Free Viewpoint Image Generation Processing)

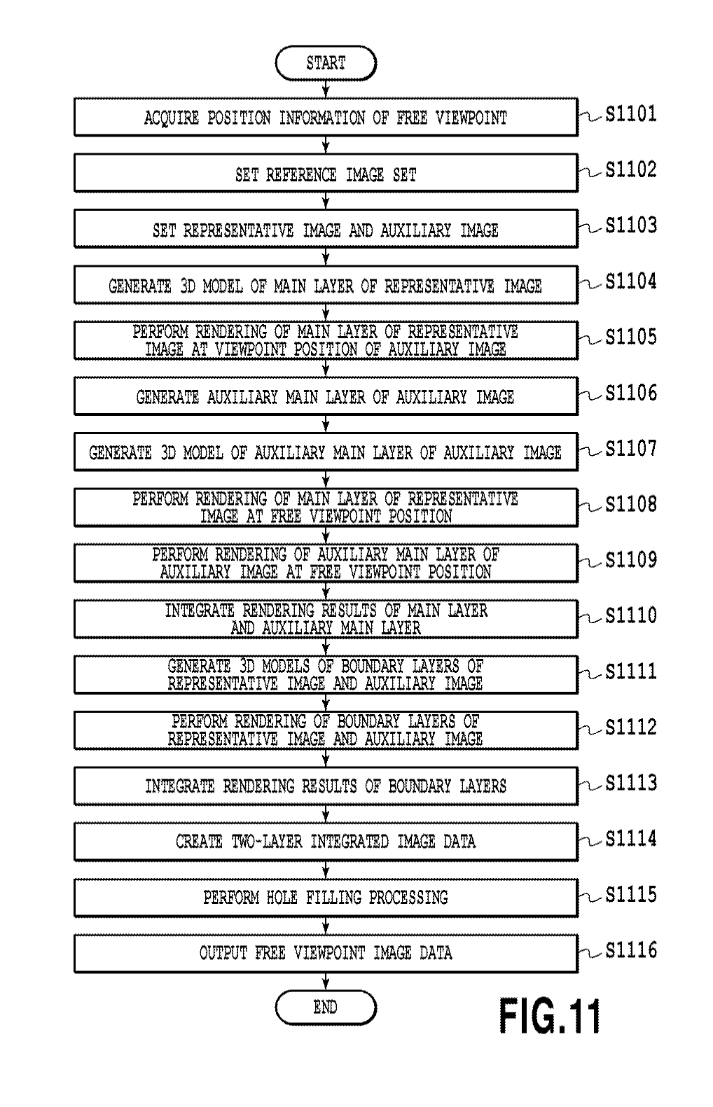

Subsequently, free viewpoint image generation processing in the free viewpoint image generation unit 403 is explained. FIG. 11 is a flowchart showing a flow of the free viewpoint image generation processing according to the present embodiment.

At step 1101, the free viewpoint image generation unit 403 acquires the position information of an arbitrary viewpoint (hereinafter, referred to as a “free viewpoint”) in the free viewpoint image to be output. For example, the position information of the free viewpoint is given by coordinates as follows. In the present embodiment, it is assumed that coordinate information indicative of the position of the free viewpoint is given in the case where the position of the image capturing unit 105 is taken to be the coordinate position (0.0, 0.0) that serves as a reference. In this case, the image capturing unit 101 is represented by (1.0, 1.0), the image capturing unit 102 by (0.0, 1.0), the image capturing unit 103 by (−1.0, 1.0), and the image capturing unit 104 by (1.0, 0.0), respectively. Similarly, the image capturing unit 106 is represented by (−1.0, 0.0), the image capturing unit 107 by (1.0, −1.0), the image capturing unit 108 by (0.0, −1.0), and the image capturing unit 109 by (−1.0, −1.0). Here, in the case where a user desires to combine an image with the middle position of the four image capturing units 101, 102, 104, and 105 as a free viewpoint, it is necessary for the user to input the coordinates (0.5, 0.5). It is a matter of course that the method for defining coordinates is not limited to the above and it may also be possible to take the position of the image capturing unit other than the image capturing unit 105 to be a coordinate position that serves as a reference. Further, the method for inputting the position information of the free viewpoint is not limited to the method for directly inputting the coordinates described above and it may also be possible to, for example, display a UI screen (not shown schematically) showing the arrangement of the image capturing units on the display unit 206 and to specify a desired free viewpoint by the touch operation etc.

Although not explained as the target of acquisition at this step, the distance information corresponding to each viewpoint image and the multi-viewpoint image data are also acquired from the distance information estimation unit 401 or the separation information generation unit 402 as described above.

At step 1102, the free viewpoint image generation unit 403 sets a plurality of viewpoint images to be referred (hereinafter, referred to as a “reference image set”) in generation of the free viewpoint image data at the position of a specified free viewpoint. In the present embodiment, the viewpoint images captured by the four image capturing units close to the position of the specified free viewpoint are set as a reference image set. The reference image set in the case where the coordinates (0.5, 0.5) are specified as the position of the free viewpoint as described above is configured by the four viewpoint images captured by the image capturing units 101, 102, 104, and 105 as a result. As a matter of course, the number of viewpoint images configuring the reference image set is not limited to four and the reference image set may be configured by three viewpoint images around the specified free viewpoint. Further, it is only required for the reference image set to include the position of the specified free viewpoint, and it may also be possible to set viewpoint images captured by four image capturing units (for example, the image capturing units 101, 103, 107, and 109) not immediately adjacent to the specified free viewpoint position as the reference image set.

At step 1103, the free viewpoint image generation unit 403 performs processing to set one representative image and one or more auxiliary images on the set reference image set. In the present embodiment, among the reference image set, the viewpoint image closest to the position of the specified free viewpoint is set as the representative image and the other viewpoint images are set as the auxiliary images. For example, it is assumed that the coordinates (0.2, 0.2) are specified as the position of the free viewpoint and the reference image set configured by the four viewpoint images captured by the image capturing units 101, 102, 104, and 105 is set. In this case, the viewpoint image captured by the image capturing unit 105 closest to the position (0.2, 0.2) of the specified free viewpoint is set as the representative image and respective viewpoint images captured by the image capturing units 101, 102, and 104 are set as the auxiliary images. As a matter of course, the method for determining the representative image is not limited to this and another method may be used in accordance with the arrangement of each image capturing unit etc., for example, such as a method in which the viewpoint image captured by the image capturing unit closer to the camera center is set as the representative image.

At step 1104, the free viewpoint image generation unit 403 performs processing to generate a three-dimensional model of the main layer of the representative image. The three-dimensional model of the main layer is generated by construction of a square mesh by interconnecting four pixels including the normal pixels not adjacent to the object boundary.

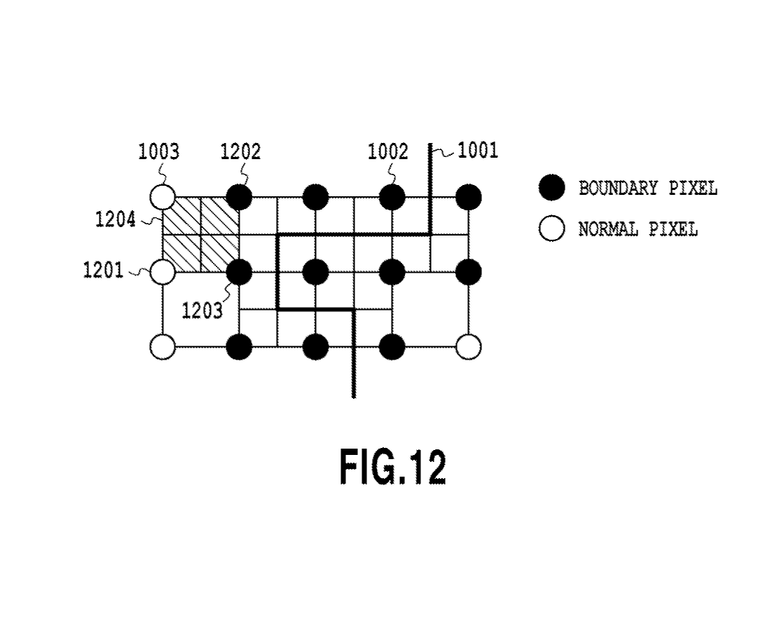

FIG. 12 is a diagram for explaining the way of generating the three-dimensional model of the main layer of the representative image. In FIG. 12, for example, a square mesh 1204 is constructed by connecting four pixels (two normal pixels 1003 and 1201, and two boundary pixels 1202 and 1203) including the normal pixels not adjacent to the object boundary 1001. By performing such processing repeatedly, all the square meshes are constructed, which form three-dimensional models of the main layer. The minimum size of the square mesh at this time is one pixel×one pixel. In the present embodiment, all the main layers are constructed by the square meshes in the size of one pixel×one pixel, but may be constructed by larger square meshes. Alternatively, it may also be possible to construct meshes in a shape other than the square, for example, triangular meshes.

To the X coordinate and the Y coordinate of the square mesh in units of one pixel constructed in the manner described above, the global coordinates calculated from the camera parameters of the image capturing unit 100 correspond and, to the Z coordinate, the distance from each pixel to the subject obtained from the distance information corresponds. Then, the three-dimensional model of the main layer is generated by texture-mapping the color information of each pixel onto the square mesh.

Explanation is returned to the flowchart in FIG. 11.

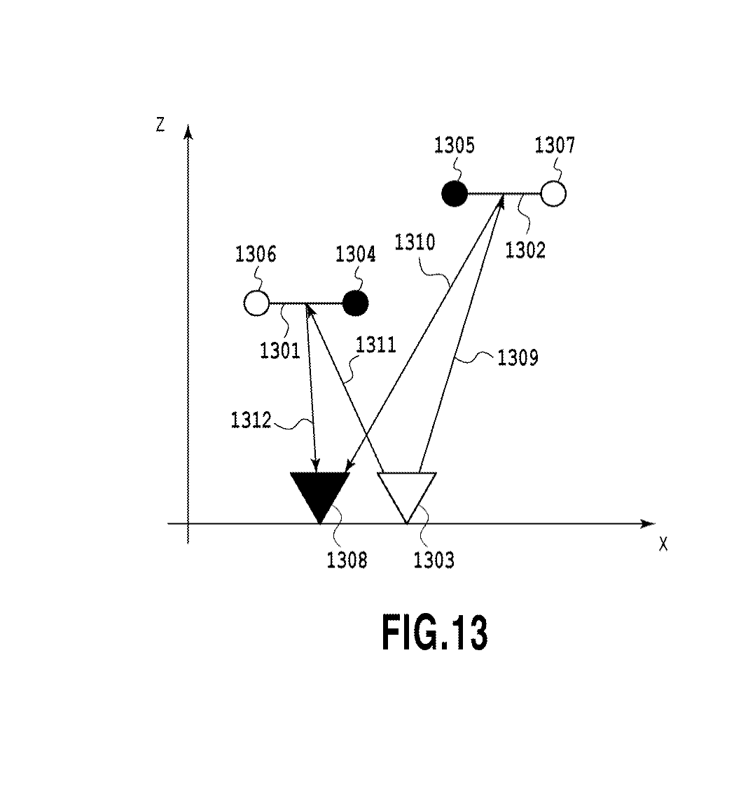

At step 1105, the free viewpoint image generation unit 403 performs rendering of the main layer of the representative image at the viewpoint position of the auxiliary image. FIG. 13 is a diagram for explaining the way of rendering the main layer of the representative image. The horizontal axis represents the X coordinate and the vertical axis represents the Z coordinate. In FIG. 13, line segments 1301 and 1302 show the square meshes of the main layer, respectively, in the case where the three-dimensional model is generated from the reference viewpoint (white-painted inverted triangle 1303), which is the viewpoint position of the representative image. Here, it is assumed that the object boundary (not shown schematically) exists between a boundary pixel 1304 and a boundary pixel 1305. As the main layer, the square mesh 1301 connecting a normal pixel 1306 and the boundary pixel 1304, and the square mesh 1302 connecting a normal pixel 1307 and the boundary pixel 1305 are generated as the three-dimensional models. The image obtained by rendering the square meshes 1301 and 1302 at a target viewpoint (black-painted inverted triangle 1308), which is the viewpoint position of the auxiliary image, is a rendered image. In the rendering processing, the pixel portion where no color exists is left as a hole. In FIG. 13, arrows 1309 and 1310 indicate in which positions the square mesh 1302 is located when viewed from the reference viewpoint 1303 and the target viewpoint 1308. From the target viewpoint 1308 located to the left of the reference viewpoint 1303, the square mesh 1302 is located to the right of the square mesh 1302 when viewed from the reference viewpoint 1303. Similarly, arrows 1311 and 1312 indicate in which positions the square mesh 1301 is located when viewed from the reference viewpoint 1303 and the target viewpoint 1308.

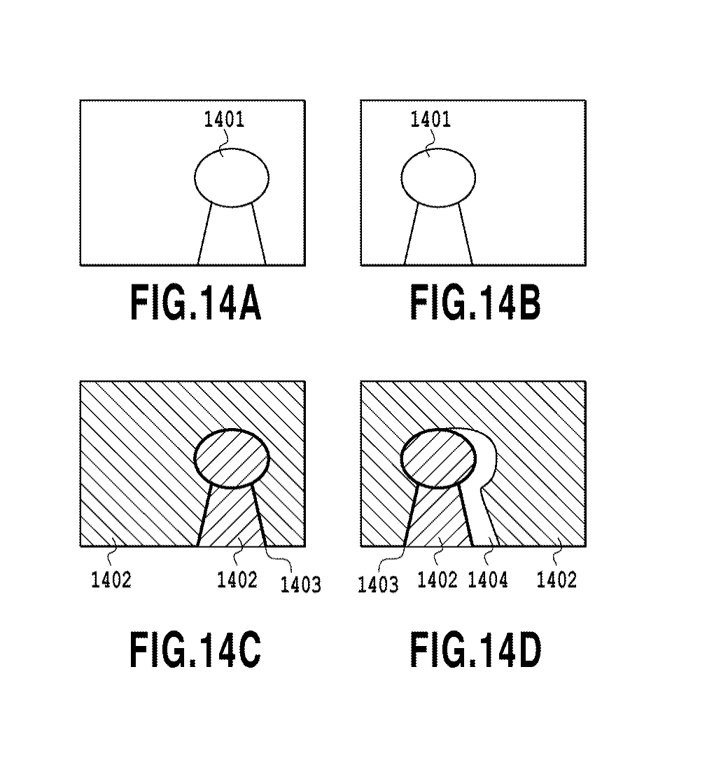

FIGS. 14A to 14D are diagrams showing an example in the case where rendering of the main layer of the representative image is performed at the viewpoint position of the auxiliary image. Here, the rendering result in the case where the viewpoint image captured by the image capturing unit 105 is taken to be the representative image and the viewpoint image captured by the image capturing unit 104 is taken to be the auxiliary image is shown. FIG. 14A shows the representative image (captured by the image capturing unit 105) and FIG. 14B shows the auxiliary image (captured by the image capturing unit 104), respectively. The image of an object 1401 is captured by the image capturing unit 105 and the image capturing unit 104, but it is known that the image of the object 1401 appears on the right side in the viewpoint image captured by the image capturing unit 105, and appears on the left side in the viewpoint image captured by the image capturing unit 104. FIG. 14C shows the main layer and the boundary layer in the representative image and a region 1402 indicated by diagonal lines is the main layer and a region 1403 indicated by the black heavy line is the boundary layer. FIG. 14D shows the result of the rendering of the region 1402 indicated by diagonal lines in FIG. 14C, that is, the main layer of the representative image at the viewpoint position of the auxiliary image. Because rendering of the boundary layer of the representative image is not performed, it is known that the boundary region 1403 is left as a hole and an occlusion region 1404 the image of which is not captured at the viewpoint position of the representative image is also left as a hole. That is, in FIG. 14D, by performing rendering of the main layer of the representative image at the viewpoint position of the auxiliary image, the boundary region 1403 and the occlusion region 1404 are left as holes.

Explanation is returned to the flowchart in FIG. 11.

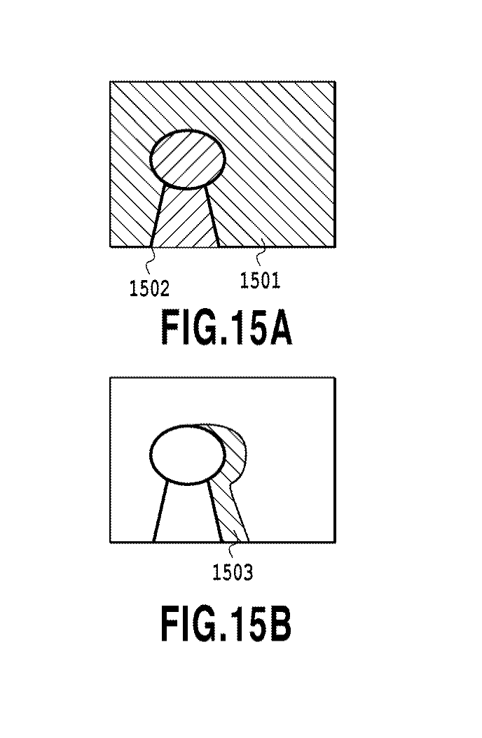

At step 1106, the free viewpoint image generation unit 403 generates an auxiliary main layer of the auxiliary image. Here, the auxiliary main layer corresponds to a difference between the main layer in the auxiliary image and the rendered image obtained at step 1105 (image obtained by rendering the main layer of the representative image at the viewpoint position of the auxiliary image). FIGS. 15A and 15B are diagrams for explaining the way of generating the auxiliary main layer. Here, it is also assumed that the viewpoint image captured by the image capturing unit 105 is taken to be the representative image and the viewpoint image captured by the image capturing unit 104 is taken to be the auxiliary image. FIG. 15A shows the boundary layer and the main layer in the auxiliary image and as in FIG. 14C, a region 1501 indicated by diagonal lines is the main layer and a region 1502 indicated by the black heavy line is the boundary layer. Here, as shown in FIG. 14D, in the image obtained by rendering the main layer of the representative image at the viewpoint position of the auxiliary image, the boundary region 1403 and the occlusion region 1404 are left as holes. As a result of that, a region 1503 (the occlusion region 1404 in FIG. 14D) corresponding to the difference between the shaded region 1501 in FIG. 15A and the shaded region 1402 in FIG. 14D is the auxiliary main layer of the auxiliary image. In this manner, the occlusion region the image of which cannot be captured from the viewpoint position of the representative image can be identified. Then, in the present embodiment, only structure information of the viewpoint image is utilized in generation of the auxiliary main layer, which is the occlusion region in the representative image, and color information is not utilized. Because of this, it is possible to omit rendering of color information, and therefore, the amount of calculation can be reduced as a result.

Explanation is returned to the flowchart in FIG. 11.

At step 1107, the free viewpoint image generation unit 403 performs processing to generate a three-dimensional model of the auxiliary main layer of the auxiliary image. The three-dimensional model of the auxiliary main layer is generated by the same processing as that of the three-dimensional model of the main layer of the representative image explained at step 1104. Here, the pixels set as the auxiliary main layer are handled as the normal pixels and other pixels as the boundary pixels. The three-dimensional model of the auxiliary main layer is generated by construction of a square mesh by interconnecting four pixels including the normal pixel not adjacent to the object boundary. The rest of the processing is the same as that at step 1104, and therefore, explanation is omitted here. Compared to the three-dimensional modeling of the main layer of the representative image, the number of pixels to be processed as the normal pixel in the three-dimensional modeling of the auxiliary main layer of the auxiliary image is small, and therefore, the amount of calculation necessary for generation of the three-dimensional model is small.

At step 1108, the free viewpoint image generation unit 403 performs rendering of the main layer of the representative image at the free viewpoint position. At step 1105, rendering of the three-dimensional model of the main layer of the representative image is performed at the viewpoint position of the auxiliary image, but at this step, rendering is performed at the free viewpoint position acquired at step 1101. This means that the reference viewpoint 1303 corresponds to the viewpoint position of the representative image and the target viewpoint 1308 corresponds to the free viewpoint position. Due to this, the image data of the region except for the above-described occlusion region obtained in the case where the image of the subject is captured from the free viewpoint position is acquired based on the three-dimensional model with the viewpoint position of the representative image as a reference. The rest of the processing is the same as that at step 1105, and therefore, explanation is omitted here.

At step 1109, the free viewpoint image generation unit 403 performs rendering of the auxiliary main layer of the auxiliary image at the free viewpoint position. That is, the free viewpoint image generation unit 403 performs rendering of the three-dimensional model of the auxiliary main layer of the auxiliary image generated at step 1107 at the free viewpoint position acquired at step 1101. This means that the reference viewpoint 1303 corresponds to the viewpoint position of the auxiliary image and the target viewpoint 1308 corresponds to the free viewpoint position in FIG. 13. Due to this, the image data of the above-described occlusion region portion obtained in the case where the image of the subject is captured from the free viewpoint position is acquired based on the three-dimensional model with another viewpoint position different from the viewpoint position of the representative image as a reference. The rest of the processing is the same as that at step 1105, and therefore, explanation is omitted here.

The image generation necessary for free viewpoint image combination is performed up to here. The processing the calculation load of which is high is summarized as follows.

Generation of the three-dimensional model of the main layer of the representative image (step 1104)

Generation of the three-dimensional model of the auxiliary main layer of the auxiliary image (step 1107)

Rendering of the main layer of the representative image at the viewpoint position of the auxiliary image (step 1105)

Rendering of the main layer of the representative image at the free viewpoint position (step 1108)

Rendering of the auxiliary main layer of the auxiliary image at the free viewpoint position (step 1109)

As to the three-dimensional model generation at step 1104 and step 1107, the number of pixels of the auxiliary main layer of the auxiliary image is smaller than the number of pixels of the main layer of the representative image, and therefore, it is possible to considerably reduce the amount of calculation compared to the case where the main layer is utilized commonly in a plurality of reference images.

In the case where it is possible to increase the speed of the rendering processing for the three-dimensional model generation by, for example, performing the rendering processing at steps 1105, 1108, and 1109 by using a GPU (processor dedicated for image processing), the effect of the present invention is further enhanced.

Explanation is returned to the flowchart in FIG. 11.

At step 1110, the free viewpoint image generation unit 403 generates integrated image data of the main layer and the auxiliary main layer by integrating the two rendering results (the rendering result of the main layer of the representative image and the rendering result of the auxiliary main layer of the auxiliary image) performed at the free viewpoint position. In the case of the present embodiment, one rendered image obtained by rendering the main layer of the representative image and three rendered images obtained by rendering the auxiliary main layer of the auxiliary image are integrated as a result. In the following, integration processing is explained.

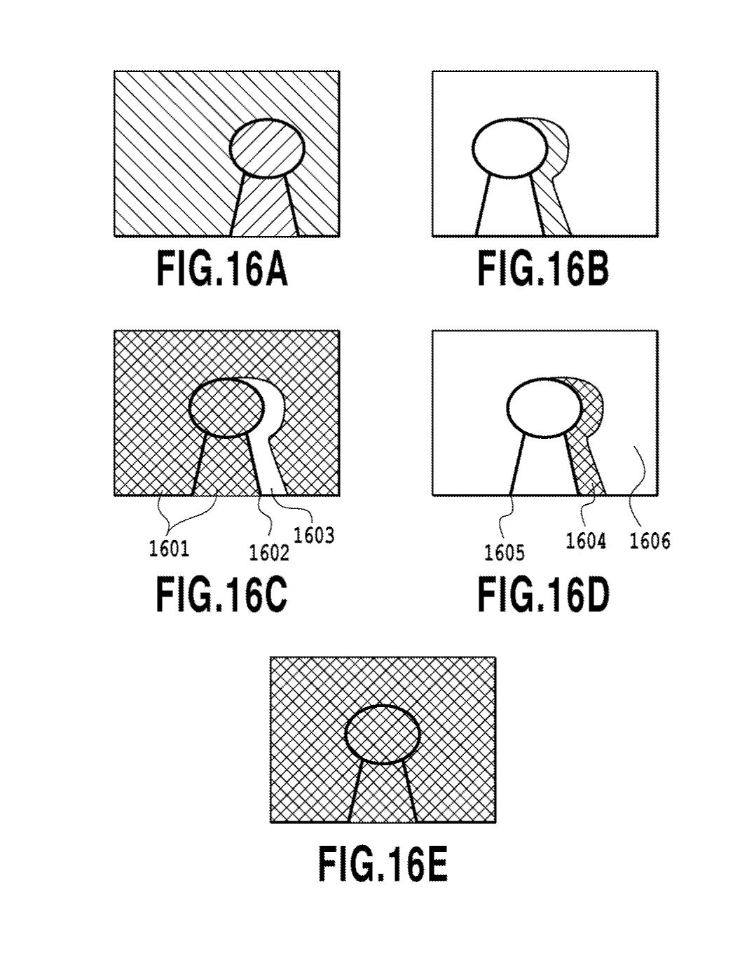

First, the integration processing is performed for each pixel. Then, the color after integration can be acquired by a variety of methods and here, a case is explained where the weighted average of each rendered image is used, specifically, the weighted average based on the distance between the position of the specified free viewpoint and the reference image is used. For example, in the case where the specified free viewpoint position is equidistant from the four image capturing units corresponding to each viewpoint image configuring the reference image set, all the weights will be 0.25, equal to one another. In the case where the specified free viewpoint position is nearer to any of the image capturing units, the shorter the distance, the greater the weight is. At this time, the portion of the hole in each rendered image is not used in color calculation for integration. That is, the color after integration is calculated by the weighted average obtained from the rendered images with no hole. The portion of the hole in all the rendered images is left as a hole. The integration processing is explained by using FIGS. 16A to 16E. For simplification of explanation, however, it is assumed that the representative image is the viewpoint image captured by the image capturing unit 105 and the auxiliary image is one of the viewpoint images captured by the image capturing unit 104. Then, it is also assumed that the free viewpoint position is a mid-viewpoint between the image capturing unit 105 and the image capturing unit 104. In FIG. 16A, the main layer of the representative image is indicated by diagonal lines and in FIG. 16B, the auxiliary main layer of the auxiliary image is indicated by diagonal lines, respectively. FIG. 16C shows the result of the rendering of the main layer of the representative image shown in FIG. 16A at the mid-viewpoint and a region 1601 indicated by hatching is the rendered region obtained from the main layer. A boundary region 1602 and an occlusion region 1603 are left as holes. Then, FIG. 16D shows the result of the rendering of the auxiliary main layer of the auxiliary image shown in FIG. 16B performed at the mid-viewpoint and a boundary 1604 indicated by hatching is the rendered region obtained from the auxiliary main layer. A boundary region 1605 and another region 1606 are left as holes. From FIG. 16C, it is known that the object is located to the left side of the object in the viewpoint image of the image capturing unit 105 (see FIG. 16A), and to the right side of the object in the viewpoint image of the image capturing unit 104 (see FIG. 16B). Then, it is also known that the occlusion region 1603 is left to the right side of the object in FIG. 16C. On the other hand, from FIG. 16D, it is known that the region 1604 corresponding to the occlusion region 1603 in FIG. 16C is the rendered region obtained from the auxiliary main layer. As described above, as a result of the rendering of the auxiliary main layer of the auxiliary image, a rendered region that complements the portion missing in the rendered image of the main layer of the representative image is obtained. By integrating the two rendered images (the rendered image of the main layer of the representative image and the rendered image of the auxiliary main layer of the auxiliary image) in a relationship of mutual complement, an image with no hole (see FIG. 16E) is obtained as a result. Here, the mid-viewpoint image of the two viewpoint images is generated for convenience of explanation, and therefore, the weights in color calculation will be 0.5, respectively. Then, for the portions with no hole, the color of each pixel in the integrated image will be the average color of both the rendered images. For the portion of the hole in one of the rendered images, the color of the pixel in the rendered image with no hole is adopted as a result. In this manner, the image at the mid-viewpoint of the viewpoint image of the image capturing unit 105 and the viewpoint image of the image capturing unit 104 is generated. For simplification of explanation, the case is explained as an example where the results of rendering of two images (one representative image and one auxiliary image) are integrated, but the concept is the same also in the case where the results of rendering of four images (one representative image and three auxiliary images) are integrated. The portion where the hole is not complemented by the integration processing will be complemented by integration processing of the rendering result of the boundary layer, to be described later. In the integration processing at this step, the region overlapping between the rendering result of the main layer of the representative image and the rendering result of the auxiliary main layer of the auxiliary image is small, and therefore, it is possible to reduce the amount of calculation as well as suppressing blurring at the time of combination.

In this manner, the integrated image data of the main layer is generated.

Explanation is returned to the flowchart in FIG. 11.

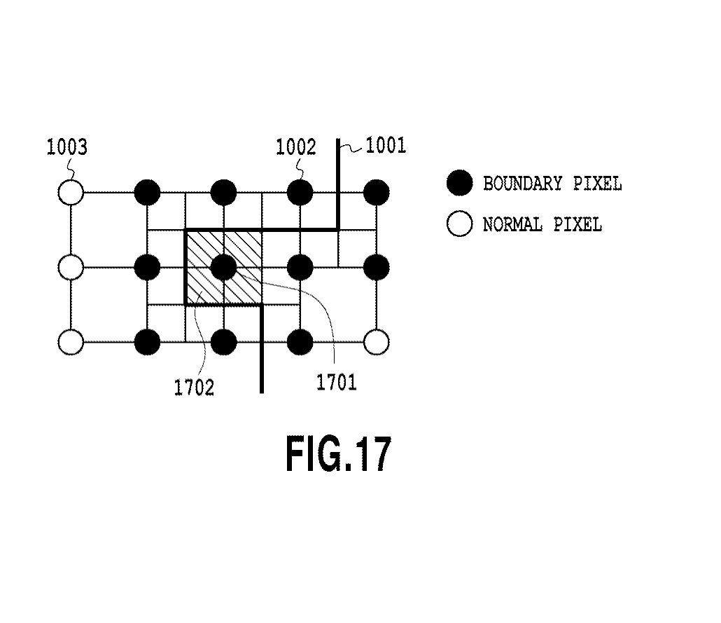

At step 1111, the free viewpoint image generation unit 403 generates 3D models of the boundary layer in the representative image and of the boundary layer in the auxiliary image. In the boundary layer in contact with the object boundary, neighboring pixels are not connected at the time of generation of the mesh. Specifically, one square mesh is constructed for one pixel and a three-dimensional model is generated. FIG. 17 is a diagram for explaining the way of generating the three-dimensional model of the boundary layer. At this step, for a boundary pixel 1701, a square mesh 1702 in the size of 1 pixel×1 pixel is constructed. The processing as described above is performed repeatedly on all the boundary pixels and all the square meshes from which the three-dimensional model of the boundary layer is generated are constructed. To the X coordinate and the Y coordinate of the square mesh in units of one pixel constructed in this manner, the global coordinates calculated from the camera parameters of the image capturing device 100 correspond, and the Z coordinate is the distance to the subject in each boundary pixel obtained from the distance information. Then, the three-dimensional model of the boundary layer is generated by taking the color information of each boundary pixel to be the color of the square mesh. Explanation is returned to the flowchart in FIG. 11.

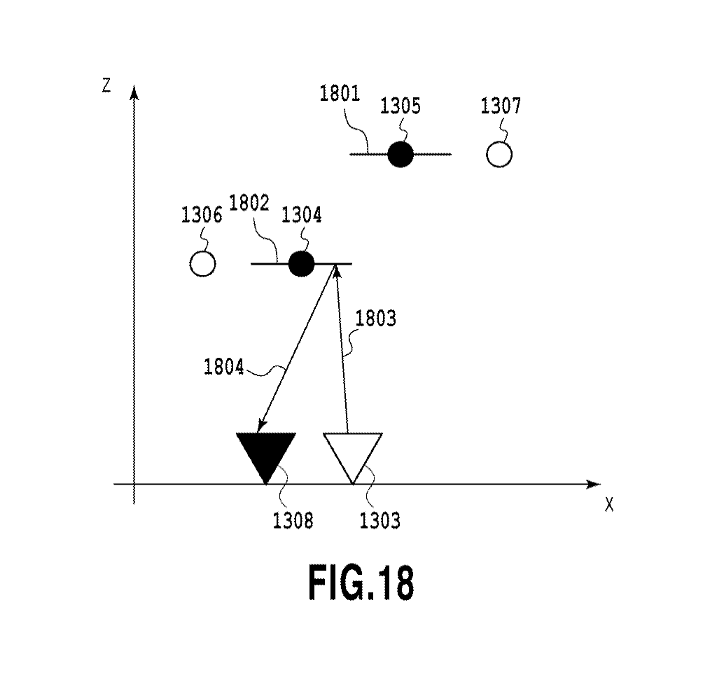

At step 1112, the free viewpoint image generation unit 403 performs rendering of the boundary layer in the representative image and the boundary layer in the auxiliary image. FIG. 18 is a diagram for explaining the way of rendering the boundary layer. As in FIG. 13, the horizontal axis represents the X coordinate and the vertical axis represents the Z coordinate and it is assumed that an object boundary (not shown schematically) exists between the boundary pixel 1304 and the boundary pixel 1305. In FIG. 18, line segments 1801 and 1802 represent square meshes of the boundary layer in the case where the three-dimensional model is generated from the reference viewpoint 1303 represented by the white-painted inverted triangle. Then, the boundary layer 1801 is a square mesh in units of one pixel having the distance information and the color information of the boundary pixel 1305 and the boundary layer 1802 is a square mesh in units of one pixel having the distance information and the color information of the boundary pixel 1304. The image obtained by rendering the square meshes 1801 and 1802 in units of one pixel at the free viewpoint position (the black-painted inverted triangle 1308 in FIG. 18) specified at step 1101 is the rendered image of the boundary layer. In the case of the rendering of the boundary layer also, the pixel portion without color is left as a hole as a result. Then, the rendering processing as described above is performed on both the representative image and the auxiliary image and the rendered image group of the boundary layer is obtained. In FIG. 18, arrows 1803 and 1804 indicate in which position the square mesh 1802 is located when viewed from the viewpoint 1303 and the viewpoint 1308. It is known that from the viewpoint 1308 located to the left side of the viewpoint 1303, the square mesh 1802 is located to the right side of the square mesh 1802 when viewed from the viewpoint 1303.

Explanation is returned to the flowchart in FIG. 11.

At step 1113, the free viewpoint image generation unit 403 obtains the integrated image data of the boundary layer by integrating the rendered image group of the boundary layer. Specifically, by the same integration processing as that at step 1110, the rendered images (four) of the boundary layer generated from the four viewpoint images (one representative image and three auxiliary images) are integrated.

At step 1114, the free viewpoint image generation unit 403 obtains integrated image data of the two layers (the main layer (including the auxiliary main layer) and the boundary layer) by integrating the integrated image data of the main layer and the auxiliary main layer obtained at step 1110 and the integrated image data of the boundary layer obtained at step 1113. This integration processing is also performed on each pixel. At this time, an image with higher precision is obtained stably from the integrated image of the main layer and the auxiliary main layer than from the integrated image of the boundary layer, and therefore, the integrated image of the main layer and the auxiliary main layer is utilized preferentially. That is, only in the case where there is a hole in the integrated image of the main layer and the auxiliary main layer and there is no hole in the integrated image of the boundary layer, complement is performed by using the color of the integrated image of the boundary layer. In the case where there is a hole both in the integrated image of the main layer and the auxiliary main layer and in the integrated image of the boundary layer, there is left a hole.

In the present embodiment, the rendering of the main layer and the auxiliary main layer and the rendering of the boundary layer are performed in this order to suppress degradation in image quality in the vicinity of the object boundary.

At step 1115, the free viewpoint image generation unit 403 performs hole filling processing. Specifically, the portion left as a hole in two-layer integrated image data obtained at step 1114 is complemented by using the ambient color. In the present embodiment, the hole filling processing is performed by selecting the pixel located to be more distant according to the distance information from among the peripheral pixels adjacent to the pixel to be subjected to the hole filling processing. It may of course be possible to use another method as the hole filling processing.

At step 1116, the free viewpoint image generation unit 403 outputs the free viewpoint image data having been subjected to the hole filling processing to the encoder unit 210. In the encoder unit 210, the data is encoded by an arbitrary encoding scheme (for example, JPEG scheme) and output as an image.

According to the present embodiment, it is made possible to combine a captured image between respective viewpoints in the multi-viewpoint image data with high precision and at a high speed, and it is possible to produce a display without a feeling of unnaturalness in a display the number of viewpoints of which is different from that of the captured image, and to improve image quality in the image processing, such as refocus processing.

### Second Embodiment

In the first embodiment, for the generation of the auxiliary main layer, the information of the region where a hole is left at the time of rendering of the main layer of the representative image at the viewpoint position of the auxiliary image is utilized. That is, the auxiliary main layer is generated by utilizing only the structure information. Next, an aspect is explained as a second embodiment, in which higher image quality is achieved by utilizing the color information in addition to the structure information for generation of the auxiliary main layer. Explanation of parts common to those of the first embodiment (processing in the distance information estimation unit 401 and the separation information generation unit 402) is omitted and here, the processing in the free viewpoint image generation unit 403, which is the different point, is explained mainly.

In the present embodiment, only the difference lies in that the color information is utilized in addition to the structure information in the generation processing of the auxiliary main layer in the free viewpoint image generation processing. Hence, the points peculiar to the present embodiment are explained mainly along the flowchart in FIG. 11 described previously.

The acquisition of the position information of the free viewpoint at step 1101, the setting of the reference image set at step 1102, and the setting of the representative image and the auxiliary image at step 1103 are the same as those in the first embodiment. The processing to generate the 3D model of the main layer of the representative image at step 1104 and the processing to render the main layer of the representative image at the viewpoint position of the auxiliary image at step 1105 are also the same as those in the first embodiment.

At step 1106, the free viewpoint image generation unit 403 generates the auxiliary main layer of the auxiliary image by using the color information. Specifically, the auxiliary main layer is generated as follows.

As in the case of the first embodiment, it is assumed that the viewpoint image captured by the image capturing unit 105 is taken to be the representative image and the viewpoint image captured by the image capturing unit 104 is taken to be the auxiliary image. At this step, the auxiliary main layer of the auxiliary image is generated from the information indicative of the boundary layer and the main layer of the auxiliary image (see FIG. 15A), the information indicative of the rendering of the main layer of the representative image at the viewpoint position of the auxiliary image (see FIG. 15A), and the information of the rendered image obtained by rendering the main layer of the representative image at the viewpoint position of the auxiliary image (see FIG. 14D).

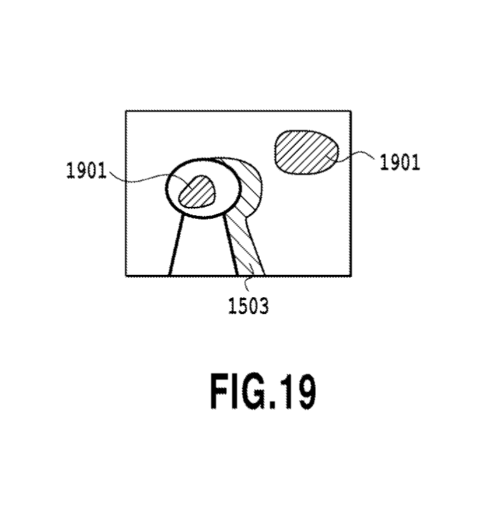

First, as in the first embodiment, the auxiliary main layer is determined based on the structure information. In this stage, the occlusion region 1503 (see FIG. 15B) is determined as the auxiliary main layer. Subsequently, the final auxiliary main layer is determined based on the color information. That is, the difference between the color information of the rendered image obtained by rendering the main layer of the representative image at the viewpoint position of the auxiliary image and the color information of the main layer in the auxiliary image is calculated and the region where the value of the difference is equal to or more than a predetermined threshold value is further determined as the auxiliary main layer. The predetermined threshold value is an arbitrary value, such as 10 in the case where the information of each color of RGB is expressed by 0 to 255. Due to this, the region where there is a change in color that causes the difference value of the color information to become equal to or more than the threshold value is added to the auxiliary main layer. FIG. 19 is a diagram showing an example of the auxiliary main layer according to the present embodiment. It is known that two regions 1901 are determined as the auxiliary main layer in addition to the region corresponding to the occlusion region 1503.

As described above, in the present embodiment, not only the structure information but also the color information is utilized for generation of the auxiliary main layer in the auxiliary image.

The subsequent processing (from step 1107 to step 1116) is the same as that in the first embodiment, and therefore, explanation is omitted here.

According to the present embodiment, by utilizing the color information in addition to the structure information for generation of the auxiliary main layer of the auxiliary image, combination processing is performed on the region where there is a change in color that cannot be expressed by rendering of only the main layer of the representative image by performing rendering of also the auxiliary main layer of the auxiliary image. Due to this, it is made possible to achieve higher image quality.

### Other Embodiments

Aspects of the present invention can also be realized by a computer of a system or apparatus (or devices such as a CPU or MPU) that reads out and executes a program recorded on a memory device to perform the functions of the above-described embodiment (s), and by a method, the steps of which are performed by a computer of a system or apparatus by, for example, reading out and executing a program recorded on a memory device to perform the functions of the above-described embodiment (s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-201478, filed Sep. 13, 2012, which is hereby incorporated by reference herein in its entirety.

What is claimed is:

1. An image processing apparatus comprising:
an identification unit configured to identify an occlusion region in which an image cannot be captured from a first viewpoint position;
a first acquisition unit configured to acquire first image data of a region other than the occlusion region obtained in a case where an image of a subject is captured from an arbitrary viewpoint position based on a three-dimensional model of the subject generated by using first distance information indicative of a distance from the first viewpoint position to the subject and taking the first viewpoint position as a reference;
a second acquisition unit configured to acquire second image data of the occlusion region obtained in a case where the image of the subject is captured from the arbitrary viewpoint position based on a three-dimensional model of the occlusion region generated by using second distance information indicative of a distance from a second viewpoint position different from the first viewpoint position to the subject and taking the second viewpoint position as a reference; and
a generation unit configured to generate combined image data obtained in a case where the image of the subject is captured from the arbitrary viewpoint position by combining the first image data and the second image data.

2. The image processing apparatus according to claim 1, wherein
the first and second distance information is a distance map showing a distance from an image capturing unit to the subject.

3. The image processing apparatus according to claim 1, wherein
the three-dimensional model generated by using the first distance information is a three-dimensional model of a region other than the occlusion region.

4. The image processing apparatus according to claim 1, further comprising:
a determination unit configured to determine a boundary layer indicating a boundary of the subject, wherein in the first and the second acquisition units, a generation method of the three-dimensional model is different between the boundary layer and a main layer indicating other than the boundary layer.

5. The image processing apparatus according to claim 4, wherein
the determination unit determines the boundary layer based on a distance to a subject.

6. The image processing apparatus according to claim 4, wherein
the determination unit determines the boundary layer based on color information of an image relating to a subject.

7. The image processing apparatus according to claim 4, wherein
in generation of a three-dimensional model of the boundary layer, the three-dimensional model is generated without connection with neighboring pixels astride the boundary of the subject.

8. The image processing apparatus according to claim 1, wherein
the first and second distance information is determined based on a parallax between an image captured at a first viewpoint position and an image captured at a second viewpoint position.

9. The image processing apparatus according to claim 1, wherein
there exists a plurality of the second viewpoint positions, and
the second acquisition unit acquires, as the second image data, pieces of image data of the occlusion region obtained in the case where the image of the subject is captured from the arbitrary viewpoint position in the number corresponding to the number of the plurality of the second viewpoint positions.

10. An image processing method comprising the steps of;
identifying an occlusion region in which an image cannot be captured from a first viewpoint position;
acquiring first image data of a region other than the occlusion region obtained in a case where an image of a subject is captured from an arbitrary viewpoint position based on a three-dimensional model of the subject generated by using first distance information indicative of a distance from the first viewpoint position to the subject and taking the first viewpoint position as a reference;
acquiring second image data of the occlusion region obtained in a case where the image of the subject is captured from the arbitrary viewpoint position based on a three-dimensional model of the occlusion region generated by using second distance information indicative of a distance from a second viewpoint position different from the first viewpoint position to the subject and taking the second viewpoint position as a reference; and
generating combined image data obtained in a case where the image of the subject is captured from the arbitrary viewpoint position by combining the first image data and the second image data.

11. A program stored in a non-transitory computer readable storage medium for causing a computer to perform the image processing method according to claim 10.
